(19) United States
(12) Patent Application Publication
(10) Pub. No.: US 2014/0034581 A1
(43) Pub. Date: Feb. 6, 2014

(54) LIQUID PRODUCTS AND METHOD FOR EMULSIFYING OIL, AND USE THEREOF IN THE TREATMENT OF OIL CONTAMINATIONS

(71) Applicant: Evgeny Vladimirovitch Belenko, Moskau (RU)

(72) Inventor: Evgeny Vladimirovitch Belenko, Moskau (RU)

(73) Assignee: MAN OIL GROUP AG, Zug (CH)

(21) Appl. No.: 14/111,054

(22) PCT Filed: Apr. 13, 2012
(86) PCT No.: PCT/EP2012/056860

§ 371 Date: Oct. 10, 2013

(30) Foreign Application Priority Data
Apr. 13, 2011 (EP) 11162199.1

(51) Int. Cl. B01D 17/04; B09C 1/08; C11D 3/382

(52) U.S. Cl. CPC B01D 17/047; C11D 3/382; B09C 1/08
USPC 210/708; 252/180; 510/365; 405/264

(57) ABSTRACT

An emulsifier concentrate for producing a working solution comprising 30-50 Vol % of a natural plant oil, selected from colza oil, corn oil, sunflower oil, 10-25 Vol % of octanol as a solubilizer, and 27-55 Vol % of an emulsifier, consisting of 26.5-45 Vol % of a non-ionic tenside, and 0.5-10 Vol % of an anionic tenside.

The present application relates to an emulsifier concentrate for producing a working solution, and a respective working solution. Additionally, the present invention relates to the use of the emulsifier concentrate and the use of the working solution in the treatment of oil contaminations, and to a method of emulsifying oil.

The present application claims the priority of the European patent application EP11162199.1 which was filed on 13 Apr. 2011 in the name of the present applicant and with the title “Liquid products and method for emulsifying oil, and use thereof in the treatment of oil contaminations”.

Many research and development experts are concerned with the treatment or elimination of oil contaminations of the surfaces of appliances and machines, which are caused for instance by the industrial processing or handling of hydrocarbons. But also oil contaminations of water, soil, sand and rocks are a major concern. There are a huge number of products and technologies in the market which can for instance be used to initiate a decontamination process.

As far as the existing products are concerned, different routes have been taken. However, until now most products which are efficient and cost-effective are to be classified as toxic materials. Known are products which initiate a chemical oxidation as well as products which in addition to the oxidation achieve a bleaching of the hydrocarbons. This causes the contamination to become less well visible.

More modern products are based on proteins or on highly efficient surfactants (tensides). There are also additives, which increase the efficiency of these products.

There is still some research ongoing regarding products which cause a natural digest or decomposition of the hydrocarbons by means of biodegradation.

A tenside used in the prior art is e.g. PEG-18 castor oil diolelate (e.g. distributed by SASOL OLEFINS & SURFACTANTS GmbH, Paul-Baumann-Str. 1, 45764 Marl, Germany, under the name MARLOWET LVS), which is a non-ionic tenside. Generally, tensides are composed of a polar head and an unpolar chain. The use of PEG-18 castor oil diolelate is of advantage due to its good industrial availability, reasonable pricing and in particular due to its relatively efficiently acting polar head, which mediates a good micelle formation. The polarity is a physical entity or unit which is measured based on the electronegativity difference (called Delta-EN (LEN). Mineral oils typically comprise a mixture of a huge number of different hydrocarbon molecules. A calculation of the polarity is thus impossible.

Good micelle formation is of particular importance, as within the micelles, the hydrocarbon chains present e.g. in mineral oil are dissolved, while the micelles themselves are distributed in the waterous solution via the polar heads of the tenside. Other non-ionic tensides known in the art are e.g. Pentaethylene glycol monododecyl ether, Polyglycerol Polyricinoleate, Lauryl glucoside.

Known in the art is also the use of a plant oil to enhance micelle formation and solving of the hydrocarbons. In particular when using PEG-18 castor oil diolelate as a tenside, the use of castor oil is preferred: as PEG-18 castor oil diolelate is based on castor oil, both are known suitable components resulting in a stable mixture, in particular for dissolving hydrocarbons with smaller chains up to C₁₂.

Also known in the art is the use of a solubilizer for diluting the micelles and to act as co-tenside. Commonly alcohols, in particular ethanol and isopropanol are used as solubilizer, but also the use of e.g. glycol ether is known.

However, known tenside compositions of the prior art have several disadvantages. A major drawback is the requirement to adopt a composition to the specific type of oil which has to be emulsified. For instance, depending on the region of origin, mineral oils comprise a specific and individual composition of various types of hydrocarbons. Accordingly, the type of oil contaminating e.g. a soil, machine or ocean slug has to be analysed with respect to a suitable tenside composition, and the effective tenside or tenside mix for a specific oil contamination is to be tailored in a series of experiments. This, however, is cumbersome and consequently time- and cost-intensive, and the resulting tenside composition might provide only a very limited effectivity with respect to other oil contaminations. Furthermore, the preparation of numerous individual tenside compositions raises problems in effective stocking. Thus, the lack of “universality” generally impairs handling properties of prior art tenside compositions.

Another disadvantage of prior art tenside compositions is the difficult recovery of tenside/oil emulsions, but there are procedures which enable the hydrocarbons to be recovered.

In the above fields so-called green technologies receive a lot of attention.

In this context the applicant has been looking for a new path in order to be able to provide a more modern and more efficient product with a larger range of applications. It was one objective target to offer a high environmental compatibility combined with an efficient and economic application.

Therefore, it is an object of the present invention to provide a composition which may be used for effectively cleaning a broad spectrum of oil-contaminated objects such as soil, slugs, sands, machines, or sea regions, and for improving the recovery of oil. Furthermore, it is an object of the present invention to provide a method of effectively emulsifying an oil contamination.

The problem is solved according to a first aspect by providing an emulsifier concentrate (herein also called new hydrocarbon solvent) for producing a working solution. The emulsifier concentrate comprises 30-50 Vol % of a natural plant oil component, selected from colza oil, corn oil, sunflower oil; 10-25 Vol % of octanol as a solubilizer, and 27-55 Vol % of an emulsifier, comprising a non-ionic tenside.

In a very efficient product, the emulsifier consists of 25-45 Vol % of a non-ionic tenside, and 0.5-10 Vol % of an anionic tensid.

The problem is solved as well by providing an emulsifier concentrate (herein also called new hydrocarbon solvent) comprising a non-ionic tenside, preferably a glycol, such as the Propylene Glycol (PG) or an Ethylene Glycol derivative as emulsifier. The hydrophobicity or hydrophilicity of the Propylene Glycol (PG) or Ethylene Glycol derivative might be tailored by means of an oxypropylene (OP) block which provides the molecule with the desired hydrophobicity and/or an oxyethylene (OE) block which gives hydrophilicity, as desired.

In particular the 1,2-Propandiol (CAS:57-55-6), as Ethylene Glycol, has a flash point beyond 102° C., which is an important characteristic. Propylene Glycol (PG) and Ethylene Glycol derivatives also have the advantage of being a very efficient emulsifiers. Propylene Glycol (PG) and Ethylene Glycol are thus an essential element of some of the formulations of the present invention.

The problem is solved according to a second aspect by providing a working solution, comprising an emulsifier concentrate according to one of the claims 1 to 7 diluted in water, in a dilution ratio of 1 part of the concentrate and 70 to 130 parts water.

The problem is solved according to a third aspect by providing a method of emulsifying oil. According to this method an emulsifier concentrate as indicated above is provided, a working solution is produced by diluting one part of the emulsifier concentrate with 70-130 parts of water, and the produced working solution is applied to the oil.

The emulsifier concentrate according to the present invention is based on a new combination of specific, single components, which are provided in specific, particularly effective concentration ranges. When provided as a concentrate, the emulsifier composition may be easily stored, and also the handling for transportation is simplified because the concentrate has a high flash point, which can be above 80° C. depending on the actual formulation of the concentrate. Furthermore, the emulsifier concentrate, when diluted with water to specific working solutions, provides a surprisingly high efficiency in the treatment of oil contaminations, including:
a faster and better solving of oil contaminations,
an improved recovery of the oil,
a larger spectrum of hydrocarbons which may be solved, simply by choosing an appropriate dilution ratio when preparing the working solution, and
a reduced toxicity for oil-degrading microorganisms, thereby improving the quality of the treated oil contaminations for a subsequent bioremediation.
The emulsifier concentrate and the working solution based thereon have excellent properties for use in a machine, such as a skimmer, for recovering oil.

A major advantage of the emulsifier concentrate according to the present invention is provided by the use of the specific natural plant oils, selected from colza oil, corn oil, sunflower oil. The inventors of the present invention have surprisingly found that these natural plant oils perform particularly well in dissolving hydrocarbons essentially independently of the present lengths of hydrocarbon chains. The natural plant oils specifically selected outperform other oils in dissolving hydrocarbons up to C₂₈. Thus, a broad spectrum of hydrocarbons and consequently a broad spectrum of oil may be reached using these three, particular plant oils. These specific natural plant oils are used in a concentration range of 30-50 volume percentage (Vol %).

Preferred is the use of colza oil as a natural plant oil component in the emulsifier concentrate according to the present invention (e.g. CAS-Nr. 93165-31-2). Colza oil is commercially available. The use of colza oil in a concentration range of 30-50 Vol % has proven to be of particular effectiveness in solving hydrocarbons, not only with respect to the spectrum of hydrocarbons which may be dissolved but also with respect to speed and efficiency of dissolving.

Especially preferred is the use of 40 Vol % colza oil as a natural plant oil component in the emulsifier concentrate according to the present invention.

A further advantage of the emulsifier concentrate according to the present invention is provided by the use of Octanol (e.g. 2-Octanol) as a solubilizer in said concentrate. Octanol has proven to be a very well suited solubilizer for the three specific natural plant oils of the emulsifier concentrate. Furthermore, Octanol reduces the viscosity of the concentrate. In particular when being combined with colza oil, the resulting mixture shows no visible segregation, even after 2 years of storage. Octanol is used in the emulsifier concentrate according to the present invention in a concentration range of 10-25 Vol %.

It is a further advantage of the inventive emulsifier that the respective oil-emulsifier emulsion has a very low density (typically less than 0.98 g/cm³ at 20° C.) which causes the emulsion to float at or near the water surface. This behaviour is very advantageous since the emulsion is easily accessible and can thus be treated or separated more easily.

Preferably, the octanol-isomer 2-octanol is used in the emulsifier concentrate according to the present invention (e.g. CAS-Nr. 123-96-6). Octanol-isomer 2-octanol is commercially available. In a particularly preferred embodiment, 2-octanol is used at a concentration of 20 Vol %. Other isomeric alcohols turned out to be not as efficient. Furthermore, the other isomeric alcohols are much more expensive. Instead of 2-octanol other isomers of 2-octanol may be used as long as their flash point is in the same range as the flash point of 2-octanol.

Preferably, octanol, 2-octanol or other isomers of 2-octanol are used which have a flash point which is greater than 70° C. This is an important aspect since the resulting flash point of the emulsifier concentrates of the invention should be greater than 80° C. and preferably even greater than 85° C.

The use of octanol does not only provide a very good solubility of the natural plant oils of the emulsifier concentrate, but additionally allows an improved handling when transporting the concentrate. This improved handling is mainly based on the low flammability respectively the high flash point of octanol, 2-octanol or other isomers of 2-octanol at room temperature. The flash point is important as far as the transportation and handling as non-hazardous material is concerned. One specific formula of the emulsifier concentrate even has a flash point of 87.8° C., allowing e.g. transportations by sea as LCL (Less Container Load) as well as via air plane. Furthermore, due to its low toxicity for oil-degrading bacteria (which is in contrast to the commonly used ethanol or isopropanol), e.g. oil contaminated soils or slugs may be further subjected to bioremediation without seriously affecting the applied microorganisms.

Please note that the tensides mentioned herein are also called surfactants. The word tenside can herein be replaced by the word surfactant.

In a third aspect, also the particular use of the specific combination of 25-45 Vol % of a non-ionic tenside and 0.5-10 Vol % of an anionic tenside in the emulsifier concentrate according to the present invention accounts to the particular advantages of said emulsifier concentrate. The use of a non-ionic tenside, in particular the use of PEG-18 castor oil diolelate is per se known in the art, however, PEG-18 castor oil diolelate is typically mixed with castor oil due to their close chemical relation. The inventors have surprisingly found that the specific combination of 25-45 Vol % of a non-ionic tenside and 0.5-10 Vol % of an anionic tenside in the emulsifier concentrate, adding up to 27-55 Vol %, results in improved emulsion properties of hydrocarbons when at the same time also using one or more of the three specific natural plant oils.

Preferably, the non-ionic tenside is 30-40 Vol % PEG-18 castor oil diolelate (e.g. CAS-Nr. 110531-96-9 of the company Sasol Germany GmbH, Werk Marl, Paul Baumann Strasse 1, D-45772 Marl, Germany). Particularly preferably, the non-ionic tenside is 35 Vol % PEG-18 castor oil diolelate.

Also preferably, the anionic tenside is selected from a group comprising dioctyl-sodium sulfosuccinate, Sodium dodecyl sulphate (CAS 151-21 3 or Tween 20-CAS 9005.04-5), and derivatives thereof. Particularly preferably is the anionic tenside dioctyl-sodium sulfosuccinate, used in a concentration of 3-7 Vol % of the emulsifier concentrate according to the present invention (e.g. of the company Sigma-Aldrich Chemie GmbH, Eschenstrasse 5, D-82024 Taufkirchen, Germany; CAS-Nr. 577-11-7). Especially preferred is the use of dioctyl-sodium sulfosuccinate as the anionic tenside in a concentration of 5 Vol % of the emulsifier concentrate.

In an especially preferred embodiment, the emulsifier concentrate comprises 40 Vol % colza oil, 20 Vol % 2-Octanol, 35 Vol % PEG-18 castor oil diolelate and 5 Vol % dioctyl-sodium sulfosuccinate.

In another preferred embodiment, the emulsifier concentrate comprises 40 Vol % colza oil, 20 Vol % 2-Octanol, and 40 Vol % of a Glycol component serving as non-ionic tenside.

The given volume percentages for the single components of the emulsifier concentrate according to the present invention essentially refer to a total volume of emulsifier concentrate of 100%.

The emulsifier concentrate is particularly suited for the application on a broad range of oil contaminations. Furthermore, as the concentrate has a flash point of 85° C. and even 87.8° C. and a shelf life of about 2 years after production of the mixture, also transportation and storage is simplified. The emulsifier concentrate is also not toxic and is biologically degradable, and may have a relative density of about 0.902.

When being applied to the object which is contaminated with oil or when being used in a machine (such as a skimmer), this emulsifier concentrate is diluted with water to produce a suitable working solution. Preferred working solutions comprising diluted emulsifier concentrate according to the present invention are prepared from dilutions in a dilution ratio of 1 part of the concentrate and 70 to 130 parts water.

In the following some examples are given in order to demonstrate that the present invention can be used in various different situations:

surfaces contaminated with light oils (so-called white products such as diesel, benzine (gasoline), kerosene, black products (crude oils up to C₁₂), and fresh hydrocarbon-based lubricants: 1:100 to 1:130, normal temperature 20-25° C.

surfaces contaminated with heavy oils, black products (crude oils from C₁₂ to C₂₈) and weathered hydrocarbon-based lubricants: 1:70 to 1:100, normal temperature 20-25° C.

Advantages of the working solution according to the present invention includes a rapid solving of contaminating oil in the emulsion solution. Additionally, the recovery of such oil is simplified, as after solving the oil to a saturated emulsion, the oil accumulates on the surface of the liquid composition.

The working solution, produced from respective dilutions of the emulsifier concentrate with water, may additionally comprise further additives. Such additives are known in the art and should therefore not be mentioned in detail at this place. Only examplarily mentioned, such additives include dyestuffs (e.g. a fluorescent substance), UV-stabilizers, identification markers for uniquely identifying the manufacturer of the emulsifier concentrate, and so forth.

The present invention also includes a method of emulsifying oil, in particular contaminations of, for example, mineral oil. The method according to the present invention comprises the steps of
providing an emulsifier concentrate according to one of the embodiments described above,
producing a working solution by diluting one part of the emulsifier concentrate with 70-130 parts of water, and
applying the produced working solution to oil.

The emulsifier concentrate and the working solution are particularly useful for the treatment of oil in soils or oil slugs on ocean surfaces, of accumulations of oil under water or on machines, or on other surfaces and products having been in contact with e.g. mineral oil. Furthermore, the emulsifier concentrate and the working solution are particularly useful in a pretreatment step. Respectively pretreated contaminated soils or slugs may later be subjected to additional processing steps. Such processing steps may be e.g. the exposure to specific oil-degrading bacteria or to a particular processing machine or machine system.

The following tables give an overview regarding the “effectivness” of various composition which have been tested. Experiments have been carried out based on a huge number of different variations and mixtures of many different ingredients and components. The below table show the total sum of the best results only. This means that the table show the respective product bars of those products which delivered the best experimental results with all possible variations of the respective other components. In other words, the tables provide a matrix representation of the results.

The first table shows the dissolving performance of hydrocarbons (here light oils only) per 60 seconds. The respective experiments have been carried out by spreading 0.05 g of a light hydrocarbon over a surface of 4 cm² of an aluminium plate. In a first group of experiments (the columns 1 through 4) mixtures of the essential other components with colza oil, sunflower oil, corn oil and castor oil have been tested. In a second group of experiments (the columns 5 through 8) mixtures of the essential other components with MARLOWET, MARLOWET plus sodium sulfosuccinate, MARLOWET plus sodium dodecyl sulphate, and MARLOWET plus Tween20 (CAS 9005-64-5) have been tested. In a third group of experiments (the columns 9 through 11) mixtures of the essential other components with Octanol, Ethanol, and Isopropanol have been tested.

Light oils

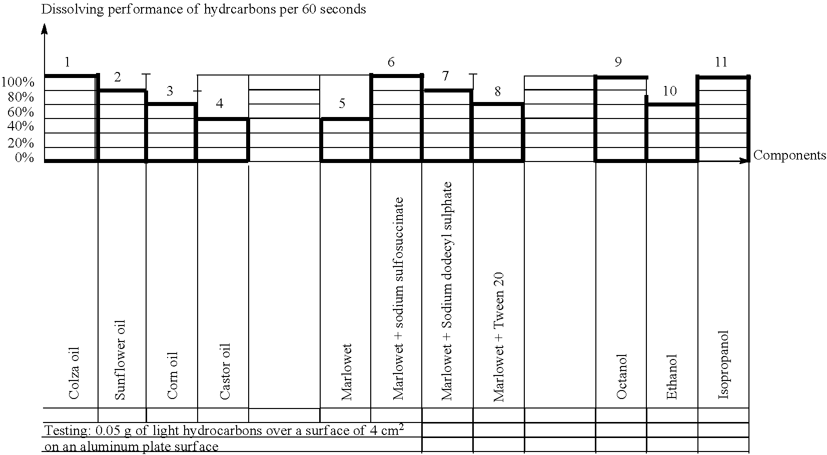

The second table shows the dissolving performance of hydrocarbons (here heavy oils) per 60 seconds and per 120 seconds. The respective experiments have been carried out by spreading 0.05 g of a heavy hydrocarbon over a surface of 4 cm² of an aluminium plate. In a first group of experiments (the columns 1.1, 1.2 through 4.1, 4.2) mixtures of the essential other components with colza oil, sunflower oil, corn oil and castor oil have been tested. In a second group of experiments (the columns 5.1, 5.2 through 8.1, 8.2) mixtures of the essential other components with MARLOWET, MARLOWET plus sodium sulfosuccinate, MARLOWET plus sodium dodecyl sulphate, and MARLOWET plus Tween20 (CAS 9005-64-5) have been tested. In a third group of experiments (the columns 9.1, 9.2 through 11.1, 11.2) mixtures of the essential other components with Octanol, Ethanol, and Isopropanol have been tested.

Heavy oils

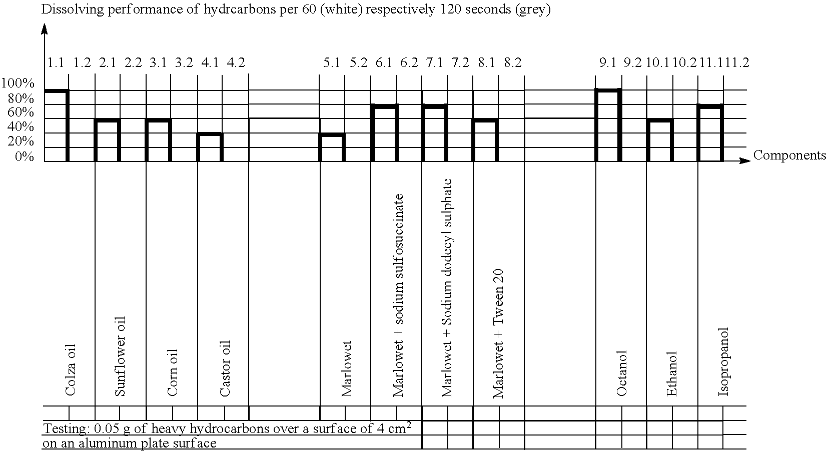

1: Emulsifier concentrate for producing a working solution, the emulsifier concentrate comprising
a) 30-50 Vol % of a natural plant oil component, selected from colza oil, corn oil, sunflower oil;
b) 10-25 Vol % of octanol as a solubilizer, and
c) 27-55 Vol % of an emulsifier comprising a non-ionic tenside

2: Emulsifier concentrate according to claim 1, wherein the natural plant oil is 35-45 Vol % colza oil.

3: Emulsifier concentrate according to claim 1, wherein the natural plant oil is 40 Vol % colza oil.

4: Emulsifier concentrate according to claim 1, wherein said emulsifier consists of 26.5-45 Vol % of the non-ionic tenside and 0.5-10 Vol % of an anionic tenside.

5: Emulsifier concentrate according to claim 1, wherein the non-ionic tenside is 30-40 Vol % PEG-18 castor oil diolelate.

6: Emulsifier concentrate according to claim 5, wherein the non-ionic tenside is 35 Vol % PEG-18 castor oil diolelate.

7: Emulsifier concentrate according to claim 4, wherein the anionic tenside is selected from a group comprising dioctyl-sodium sulfosuccinate, or derivatives thereof.

8: Emulsifier concentrate according to claim 4, wherein the anionic tenside is 0.5-7 Vol % dioctyl-sodium sulfosuccinate.

9: Emulsifier concentrate according to claim 8, wherein the anionic tenside is 5 Vol % dioctyl-sodium sulfosuccinate.

10: Emulsifier concentrate according to claim 1, comprising 15-25 Vol % 2-Octanol or an isomer of 2-Octanol.

11: Emulsifier concentrate according to claim 5, comprising 20 Vol % 2-Octanol.

12: Emulsifier concentrate according to claim 1, wherein the components a), b) and c) summarize to 100 Vol %.

13: Concentrate according to claim 1, comprising
40 Vol % colza oil,
20 Vol % 2-Octanol
39.5 Vol % PEG-18 castor oil diolelate,
0.5 Vol % dioctyl-sodium sulfosuccinate.

14: Concentrate according to claim 1, comprising
40 Vol % colza oil,
20 Vol % 2-Octanol,
40 Vol % Propylene Glycol (PG) or an Ethylene derivative as non-ionic tenside.

15: Working solution, comprising an emulsifier concentrate according to claim 1 diluted in water, in a dilution ratio of 1 part of the concentrate and 70 to 130 parts water.

16: Use of an emulsifier concentrate according to claim 1 in the preparation of a solvent solution for the treatment of oil contamination, wherein the concentrate is diluted with water in a dilution ratio of 1 part of the concentrate and 70 to 130 parts water.

17: Use of a working solution according to claim 15, for the treatment of contaminations with light oil in dilution ratios of 1:100 to 1:130, and for the treatment of contaminations with heavy oil in dilution rations of 1:70 to 1:100

18: Method of emulsifying oil, comprising the steps of providing an emulsifier concentrate according to claim 1,
producing a working solution by diluting one part of the emulsifier concentrate with 70-130 parts of water, and
applying the produced working solution to oil.
